(19) United States
(12) Patent Application Publication
(10) Pub. No.: US 2012/0222525 A1
(43) Pub. Date: Sep. 6, 2012

(54) TOOL HANDLE AND METHOD FOR MANUFACTURING THE SAME

(75) Inventor: Jianping Qiu, Hangzhou City (CN)

(73) Assignees: HANGZHOU GREAT STAR TOOLS CO., LTD., Hangzhou City (CN); HANGZHOU GREAT STAR INDUSTRIAL CO., LTD., Hangzhou City (CN)

(21) Appl. No.: 13/390,411

(22) PCT Filed: Feb. 23, 2010
(86) PCT No.: PCT/CN2010/070720

§ 371 Date: Apr. 26, 2012

(30) Foreign Application Priority Data
Aug. 14, 2009 (CN) 200910056477.0

(51) Int. Cl. B25G 1/10; B23P 11/00

(52) U.S. Cl. 81/489; 29/428

(57) ABSTRACT

The present invention provides a tool handle and manufacturing method thereof. The tool handle includes a handle body with a gripping part, and a covering layer that covers a part or whole of the gripping part. The covering layer is made of an artificial leather material. The manufacturing method for the tool handle includes the step of covering the artificial leather material on the gripping part of the handle body, so as to form the covering layer that covers a part or whole of the gripping part. The tool handle and manufacturing method thereof according to the present invention can effectively improve the anti-skid and shock absorbing performance of the tool handle and reduce molding dies and injection molding steps. Therefore, the present invention is simple in manufacturing method and low in production cost.

### FIELD OF THE INVENTION

The present invention relates to the field of mechanical manufacturing, and more particularly, relates to a tool handle and a manufacturing method thereof.

### DESCRIPTION OF THE PRIOR ART

In the prior art, the material used for tool handles may be wood, metal and rigid plastics. By means of pressing patterns or laser engraving patterns on the surface of tool handles, it is feasible to increase the friction force of the tool handles and thus improve the anti-skid performance of the tool handles. However, such manufacturing process is relatively complicated and unable to realize the shock absorption function of the tool handles. In addition, since the materials such as wood, metal and rigid plastics used for making tool handles have relatively high hardness, the hand feeling of such tool handles is poor.

Chinese patent application with the application number 38159601.4 provides a shock-absorbing tool handle having a handle core covered with an internal shock-absorbing layer and an external shock-absorbing layer from inside to outside in turn. The internal shock-absorbing layer and the external shock-absorbing layer are formed through two injection molding processes, respectively. The internal shock-absorbing layer is fixed on the handle core through a locating piece or directly formed on the handle core through the injection molding. The external shock-absorbing layer and the internal shock-absorbing layer are integrated through the convex ribs that are respectively disposed on them. By way of two-stage cushion composed of the external shock-absorbing layer and internal shock-absorbing layer, the anti-skid performance of the tool handle according to this patent application can be effectively improved, and thus the vibration impact can be reduced. However, the internal shock-absorbing layer and the external shock-absorbing layer according to this patent application are formed by using two pairs of dies through two injection molding processes. Once the defects such as flash, crazing, bubble and/or charred streaks occur in the process of rubber covering and injection molding, the whole tool handle will be scrapped. Thus it can be observed that the tool handle of this patent application has relatively higher manufacture difficulty and production cost.

### SUMMARY OF THE INVENTION

In view of the above, the technical object of the present invention is to provide a tool handle and manufacturing method thereof, so as to effectively improve the anti-skid and shock absorption performance of tool handle and reduce the number of molding dies and the injection molding steps. This tool handle is simple to manufacture and low in production cost.

The following technical schemes are adopted by the present invention to achieve the technical object.

A tool handle including a handle body with a gripping part is provided, wherein the tool handle further includes a covering layer that covers a part or whole of the gripping part, and the covering layer is made of an artificial leather material.

Further, the covering layer is fixed on the gripping part in the form of a sheet.

Further, the sheet covers the gripping part in the mode of a covering sheath.

Further, the sheet includes two opposite transverse edges and two opposite longitudinal edges, and the longitudinal edges are jointed to form the covering sheath.

Further, the joint of the two longitudinal edges is carried out with hot-melt adhesive, stitching, scarf joint or adhesive.

Further, the sheet is fixed on the gripping part with adhesive.

Further, the tool handle also includes a member for preventing at least one of the transverse edges from being turned up.

Further, the member for preventing the edge from being turned up is a holding hoop, which is used to hold at least one of the transverse edges on the gripping part.

Further, the member for preventing the edge from being turned up is the shoulder of the handle body that protrudes along the transverse direction, and the shoulder leans against the transverse edge of the sheet.

Further, retaining parts protruding along the longitudinal direction are disposed on the positions where the handle body is connected with both ends of the covering layer, the retaining parts and the handle body are integrally made, and the transverse edges of the covering layer are pressed tightly with the retaining parts.

Further, the sheet covers the gripping part in the form of a single or multiple patches and/or a single or multiple complete circles of collars.

Further, the handle body includes a connecting end part connecting to a working part, and an opposite free end part, wherein the gripping part extends between the connecting end part and the free end part; radial dimensions of the connecting end part and the free end part are respectively larger than corresponding radial dimensions of portions where the gripping part is connected with the connecting end part and the free end part, so that shoulders are formed to prevent longitudinally movement of the covering layer along the tool handle.

Further, a radial dimension of the gripping part keeps constant to form a depression with an even depth between the free end part and the connecting end part, for containing the covering layer.

Further, a radial dimension of the gripping part gradually decreases or increases from the free end part to the connecting end part, to form a depression with a depth changing evenly between the free end part and the connecting end part, for containing the covering layer.

Further, at positions where the connecting end part and the free end part adjoin the covering layer, an outer peripheral surface of the covering layer is aligned with rims of the connecting end part and the free end part.

Further, the handle body further includes a through hole radially perforating through the gripping part and the covering layer, and a fastener passing the through hole to fix the covering layer and the gripping part.

Further, a cross section of the handle body is an ellipse in shape, the ellipse including a major axis and a minor axis, wherein the through hole is perpendicular to the major axis and radially perforates through the handle body.

Further, the fastener is a rivet, a screw or an expansion screw.

Further, the fastener includes a first component and a second component which can mate with each other; through mating of the first component and the second component, the covering layer and the gripping part are held between the first component and the second component.

Further, after the first component mates with the second component, ends of the first component and the second component are partially or completely aligned with outlets of the through hole of the covering layer.

Further, the first component is a bolt and the second component is a nut for mating therewith.

Further, the first component is a pin including a barb head, and the second component is a pin boss including an receiving part mating with the barb head.

Further, the pin includes a pin rod, a side of the pin rod and a side of the receiving part each are provided with a locating piece, mating respectively with locating slots in the through hole of the gripping part, to position the pin and the pin boss to the gripping part.

Further, the handle body includes a handle core and a jacket that covers the handle core, and the jacket constitutes the gripping part.

Further, the handle body also includes an inner liner located between the handle core and the jacket.

Further, the material for the jacket is harder than the material for the inner liner.

Further, the inner liner and the jacket are integrally made through injection molding.

Further, interference fit is formed between the inner liner and the handle core.

Further, several bulges or concave parts are disposed on an outer peripheral surface of the covering layer, so as to improve the anti-skid performance.

Further, the artificial leather material is a polyurethane material.

Further, the tool is a hardware tool.

Further, the hardware tool is a hammer, a flashlight, a screwdriver, a pair of pliers, a wrench, an electric tool, a cutter, a claying tool, a wood chisel, a tommy bar, a measuring tool, a punch chisel, a painting tool or a saw.

The present invention also provides a method for manufacturing a tool handle, which is realized through the following technical solutions.

The tool handle includes the handle body, and the manufacturing method includes a step of covering the gripping part of the handle body with the artificial leather material, so as to form the covering layer that covers a part or whole of the gripping part.

Further, the covering layer is formed by covering the gripping part with a sheet.

Further, the sheet forms a covering sheath and thus covers the gripping part.

Further, two longitudinal edges of the sheet are jointed together to form the covering sheath.

Further, the two longitudinal edges of the sheet are jointed together by bonding with adhesive, stitching, scarf joint or hot melting.

Furthermore, the sheet is bonded on the gripping part of the handle body with adhesive.

Further, the handle body includes a handle core and a jacket that can form interference fit with the handle core; after the jacket is covered with the covering layer, the jacket is sleeved on the handle core.

Further, the handle body includes a handle core and a covering layer that can form interference fit with the handle core; after the jacket is sleeved on the handle core, the jacket is covered with the covering layer.

Further, the handle body includes a handle core, a jacket and an inner liner located between the handle core and jacket; the inner liner is formed in the jacket through injection molding and can form interference fit with the handle core; after the jacket is covered with the covering layer, the inner liner is sleeved on the handle core.

Further, the handle body includes a handle core, a jacket and an inner liner located between the handle core and jacket, the inner liner is formed in the jacket through injection molding and can have interference fit with the handle core; after the inner liner is sleeved on the handle core, the jacket is covered with the covering layer.

Further, the artificial leather material is a polyurethane material.

Further, the tools are hardware tools.

Further, the hardware tool is a hammer, a flashlight, a screwdriver, a pair of pliers, a wrench, an electric tools, a cutter, a claying tool, a wood chisel, a tommy bar, a measuring tool, a punch chisel, a painting tool or a saw.

According to the tool handle and manufacturing method thereof as provided by the present invention, the covering layer directly covers the gripping part of handle body, in instead of realizing the combination between the covering layer and the gripping part through dies and injection molding steps. Therefore, the present invention is characterized by simple manufacturing method, low production cost and good hand feeling in gripping.

The covering layer of the present invention covers the handle body in the form of a sheet. Through the holding hoop, the retaining part on the handle body or the shoulder on the handle body, protection for the transverse edges of the covering layer sheet is provided, so as to prevent the transverse edges of the sheet from being turned up by a hand during gripping and thus being separated from the gripping part of the handle body.

The handle body of the present invention further includes the jacket and the inner liner, and the covering layer covers the jacket. The three stages of cushion composed of the inner liner, the jacket and the covering layer can effectively buffer and absorb the vibration and impact transmitted from the handle core.

Interference fit is realized between the handle core and the inner liner of the present invention. Accordingly, such interference fit can reduce the accuracy requirement for the handle core and the jacket, and can prevent the sloshing motion between the handle core and the inner liner effectively.

The covering layer of the present invention is made of an artificial leather material. Being soft and wear resistant and having good hand feeling in gripping, this material can effectively improve the shock absorption performance of the tool handle. In addition, having big friction coefficient, this material can also effectively enhance the anti-skid performance of the tool handle.

Several bulges or concave parts are disposed on an outer peripheral surface of the covering layer of the present invention, so as to further increase the friction force between the hand and the covering layer and improve the anti-skid performance of the tool handle.

According to the manufacturing method of the present invention, before the handle core is inserted into the jacket, the jacket is separately covered. The step of covering is simple and convenient. In addition, the step of covering the jacket and the step of manufacturing the handle core can be completed in different times and places, so that the efficiency of manufacturing the tool handle is significantly improved.

### BRIEF DESCRIPTION OF THE DRAWINGS

FIG. 1 is a partial section view of a hammer of embodiment 1 of the present invention;

FIG. 2 is the section view taken along A-A line of FIG. 1.

FIG. 3 is a structural schematic diagram of a sheet of covering layer of embodiment 1 of present invention;

FIG. 4 is a structural schematic diagram of the gripping part of embodiment 1 of the present invention;

FIG. 5 is a structural schematic diagram of the gripping part of another embodiment of the present invention;

FIG. 6 is a structural schematic diagram of the pin of embodiment 1 of the present invention.

FIG. 7 is a structural schematic diagram of the pin boss mating with the pin of embodiment 1 of the present invention;

FIG. 8 is a front view of a wood chisel of embodiment 2 of present invention;

FIG. 9 is a partial section view of the wood chisel of embodiment 2 of the present invention;

FIG. 10 is a front view of a cutter of embodiment 3 of the present invention;

FIG. 11 is the section view taken along B-B line of FIG. 10;

FIG. 12 is a front view of a screwdriver of embodiment 4 of the present invention;

FIG. 13 is a section view of the screwdriver of embodiment 4 of the present invention;

FIG. 14 is a front view of another screwdriver of embodiment 5 of the present invention;

FIG. 15 is a section view of another screwdriver of embodiment 5 of the present invention;

FIG. 16 is a partial section view of a pair of pliers of embodiment 6 of the present invention;

FIG. 17 is a section view of a tommy bar of embodiment 7 of the present invention;

FIG. 18 is a partial section view of a wrench of embodiment 8 of the present invention;

FIG. 19 is a section view of the claying tool of embodiment 9 of the present invention;

FIG. 20 is a partial section view of a punch chisel of embodiment 10 of the present invention;

FIG. 21 is a section view of a flashlight of embodiment 11 of the present invention;

FIG. 22 is a front view of a level ruler of embodiment 12 of the present invention;

FIG. 23 is the section view taken along C-C line of FIG. 22;

FIG. 24 is a front view of a wallboard saw of embodiment 13 of the present invention;

FIG. 25 is a section view of the wallboard saw of embodiment 13 of the present invention;

FIG. 26 is a front view of a handsaw of embodiment 14 of the present invention;

FIG. 27 is the section view taken long D-D line of FIG. 26;

FIG. 28 is a partial section view of an electric tool of embodiment 15 of the present invention.

### DETAILED DESCRIPTION OF THE PREFERRED EMBODIMENTS

The present invention will be described in detail hereinafter in combination with the attached drawings and embodiments.

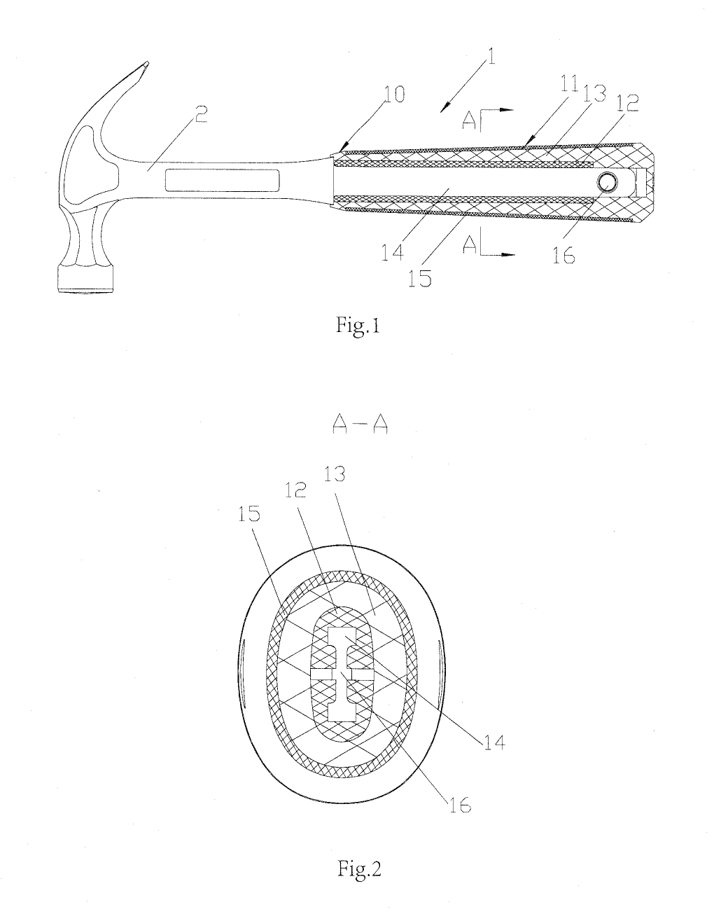

FIG. 1 is a partial section view of a hammer of embodiment 1 of the present invention. This embodiment is the improvement specially made on the tool handle of the hammer. As shown in FIG. 1, the hammer includes a handle 1 and a working part 2. The handle 1 includes a handle body 10 on which an annular depression 11 is disposed to form the gripping part designed for being gripped with a hand; and a covering layer 15, covering a part or whole of the gripping part.

Further, the handle body 10 includes a handle core 14, which is integrally connected with the working part 2 of the hammer; an inner liner 12, which is sleeved on the handle core 14 and directly contacts the handle core 14 to effectively absorb the vibration generated by the hammer in the process of hammering; and a jacket 13, which is integrally made with the inner liner 12 through injection molding and is used for the profile shaping of handle 1. The jacket 13 is made of such material as ABS (acrylonitrile-styrene-butadiene copolymer), PP (polypropylene) or nylon, etc. The inner liner 12 is made of such material as modified PVC (polyvinyl chloride), thermoplastic elastomer TPE/TPR/TPU or rubber, etc. The depression 11 is disposed on the jacket 13 to form the gripping part for being gripped by a hand. The covering layer 15 is embedded in the depression 11. The covering layer 15 is made of an artificial leather material. Interference fit is formed between the handle core 14 and the inner liner 12, and thus it is feasible to reduce the accuracy requirement for the handle core 14 and the jacket 13 and to prevent the sloshing motion between the handle core 14 and the inner liner 12 effectively.

The artificial leather material is a kind of material that is similar to leather in terms of appearance and hand feeling and thus can substitute for the leather in use. Generally, such material is made by coating textile fabric, which is used as a substrate, with mixed materials, which are formed by synthetic resin with added various plastic additives. As a general rule, the artificial leather produced with PVC resin as the raw material is named as PVC artificial leather; the artificial leather produced with PU resin as the raw material is named as PU artificial leather; and the artificial leather produced with PU resin and non-woven fabrics as the raw material is named as PU synthetic leather. Such type of material is similar to natural leather. Preferably, the covering layer 15 is made of a polyurethane (PU) material, i.e., a PU artificial leather material.

In this embodiment, the handle body 10 includes the inner liner 12 and the jacket 13, and the gripping part of the periphery of the jacket 13 is also covered with the covering layer 15. The three stages of cushion composed of the inner liner 12, the jacket 13 and the covering layer 15 can effectively buffer and absorb the vibration and impact transmitted from the handle core. Certainly, the handle body of the present invention can merely include the jacket 13, which is sleeved on the handle core 14.

In this embodiment, the material for the jacket 13 is preferably harder than the material for the inner liner 12. Certainly, the material for the jacket 13 may be the same as the material for the inner liner 12.

Further, the handle body 10 also includes a through hole 16, which is designed for inserting a fastener to fix the jacket 13 and the covering layer 15. As shown in FIG. 2, the cross section of the handle body 10 is elliptic in shape, and the depression 11 is also annularly elliptic in shape correspondingly. The ellipse includes a major axis and a minor axis, and the through hole 16 is perpendicular to the major axis of ellipse and runs through the handle body 10 in the transverse direction.

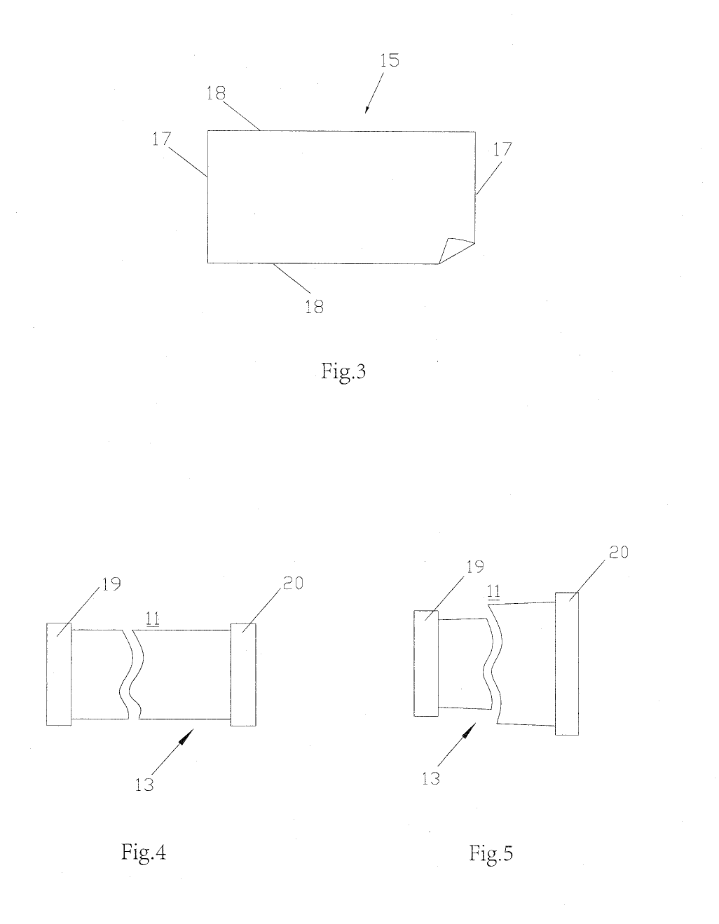

In this embodiment, the direction of the body of the handle 1 is defined as the longitudinal direction, and the direction perpendicular to the body of the handle 1 is defined as the transverse direction. FIG. 3 is a structural schematic diagram of a sheet of covering layer of embodiment 1 of the present invention. As shown in FIG. 3, the covering layer 15 is a sheet, including two opposite transverse edges 17 and two opposite longitudinal edges 18; the longitudinal edges 18 of the covering layer 15 tightly wrap on the gripping part of the jacket 13 along the longitudinal direction of the handle 1, namely in the depression 11. Two longitudinal edges 18 of the covering layer 15 are jointed by bonding with adhesive, stitching, scarf joint or hot melting, etc., so as to form a covering sheath that is sleeved on the gripping part of jacket 13.

Further, the covering layer 15 also may be bonded onto the gripping part of the jacket 13 with adhesive, so as to prevent the covering layer 15 from dropping off from the gripping part of the jacket 13.

FIG. 4 is a structural schematic diagram of the gripping part formed by the jacket 13 as shown in FIG. 1. The jacket 13 includes a connecting end part 19, which is used to connect with the working part 2; a free end part 20, which can extend along the longitudinal direction of handle 1. A depression 11 is disposed on the jacket 13 to form the gripping part, which extends between the connecting end part 19 and the free end part 20. The radial dimensions A of the connecting end part 19 and the free end part 20 are respectively bigger than the corresponding radial dimensions B of the portions where the gripping part is connected with them, so that two shoulders protruding along the transverse direction are formed. As shown in FIG. 4, the covering layer 15 is placed in the depression 11, and two transverse edges of the covering layer 15 respectively lean against two shoulders and closely contact the connecting end part 19, the free end part 20 and the bottom of the depression 11 (namely the gripping part), so as to prevent the two transverse edges of the covering layer 15 from being turned up by a hand in gripping and thus being separated from the gripping part of the handle body.

In this embodiment, two transverse edges of the covering layer 15 respectively lean against two shoulders protruding along the transverse direction, and the covering layer 15 completely covers the gripping part of the jacket 13. Certainly, the two transverse edges of the covering layer 15 may also not lean against two shoulders, and that is to say, the covering layer 15 can partially cover the gripping part of the jacket 13.

Please refer to FIG. 4. In this embodiment, with the radial dimension of the gripping part remaining unchanged, the depression 11 with an even depth is formed between the connecting end part 19 and the free end part 20.

As shown in FIG. 5, in another embodiment of the present invention, the radial dimension of the gripping part gradually increases from the connecting end part 19 to the free end part 20, so that the depression 11 with its depth evenly changed is formed between the connecting end part 19 and the free end part 20. Certainly, the radial dimension of the gripping part may also gradually decrease from the connecting end part 19 to the free end part 20.

In this embodiment, the depression 11 does not run through the jacket 13, and the length of the bottom of the depression 11 is less than the longitudinal length of the jacket 13. In another embodiment of the present invention, the depression 11 runs through the jacket 13, and the length of the bottom of the depression 11 is equivalent to the longitudinal length of the jacket 13.

In addition, the depression 11 may have other shape, and the two end parts of the depression 11 and the shoulders may be rounded.

Furthermore, please refer to FIG. 1 and FIG. 2. In this embodiment, the fastener can be placed in the through hole 16 to fix the covering layer 15, the jacket 13 and the handle core 14, so as to further prevent the covering layer 15 from dropping off from the jacket 13 and prevent the jacket 13 from dropping off from the handle core 14. The fastener may be a rivet, a screw or an expansion screw, etc., and any fastener that can be inserted into the through hole 16 is applicable to the present invention.

The fastener can also be composed of a first component and a second component that mate with each other. Through the mating of the first component and the second component, the covering layer 15 and the gripping part of the jacket 13 are held between the first component and the second component.

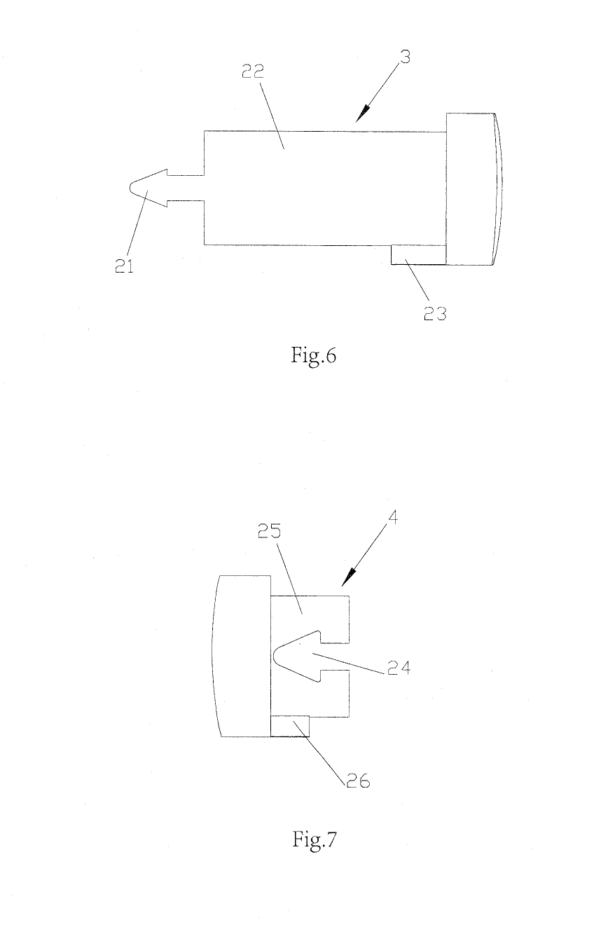

In this embodiment, the first component is a pin, and the second component is a pin boss mating with the pin. FIG. 6 is a structural schematic diagram of the pin of embodiment 1 of the present invention. FIG. 7 is a structural schematic diagram of the pin boss to mate with the pin of embodiment 1 of the present invention. As shown in FIG. 6, the pin 3 includes a barb head 21, which is used for being inserted into the pin boss 4 mating with the pin, so as to fix the covering layer 15, the jacket 13 and the handle core 14; a pin column 22, which is combined with the barb head 21 to realize the close fit between the barb head 21 and the pin boss 4; and a first locating piece 23, which is designed to accurately locate the relative position between the inner liner 12 and the pin 3. As shown in FIG. 7, the pin boss 4 mating with the pin 3 includes a barb-shaped cavity 24 which is formed in a receiving part 25 and into which the barb head 21 may be inserted to form the close fit between the barb head 21 and the pin boss 4, so as to prevent the pin 3 from dropping off from the pin boss 4; and a second locating piece 26, which is located on one side of the receiving part 25 and is combined with the first locating piece 23 of pin 3 to accurately locate the relative position among the pin 3, the pin boss 4 and the inner liner 12.

In another embodiment of the present invention, the first component of the fastener may be a bolt, and the second component may be a nut. Through the mating of the bolt and the nut, the covering layer 15 and the gripping part of the handle body 10 are held between the bolt and the nut.

In this embodiment, only a through hole 16 is disposed in the jacket 13. Certainly, multiple through holes 16 also may be disposed in the jacket 13, and then multiple fasteners can mate with the multiple through holes 16, so as to further enhance the function of fixing.

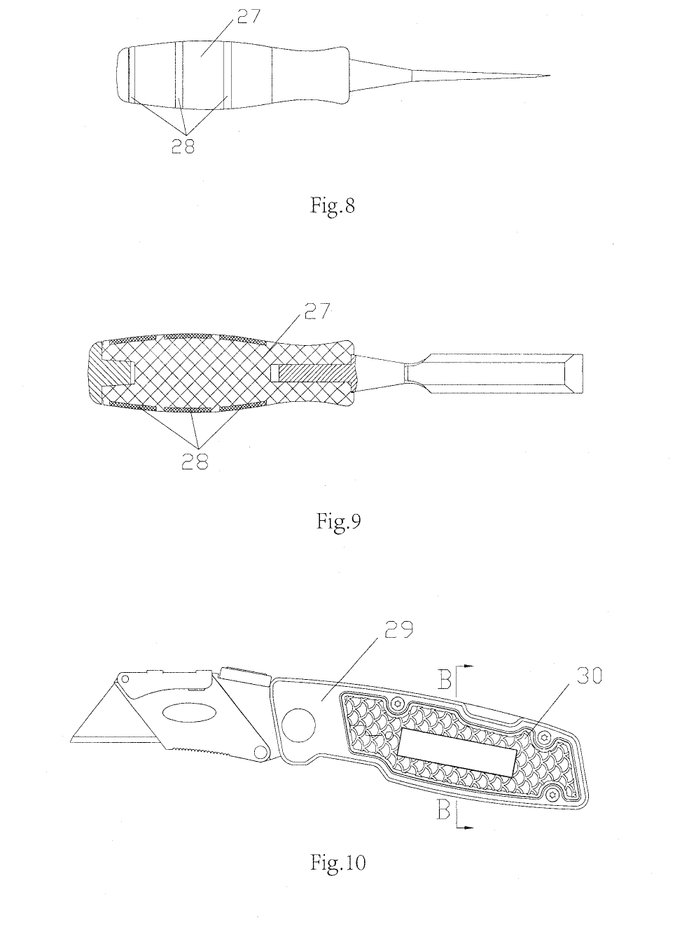

FIG. 8 is a front view of a wood chisel of embodiment 2 of the present invention. FIG. 9 is a partial section view of the wood chisel of embodiment 2 of the present invention. As shown in FIG. 8 and FIG. 9, the handle of the wood chisel includes a handle body 27, and covering layers 28, which covers the gripping part of the handle body 27 in segments. Designed in the form of complete circles of collars, the covering layer 28 tightly covers the gripping part of the handle body 27.

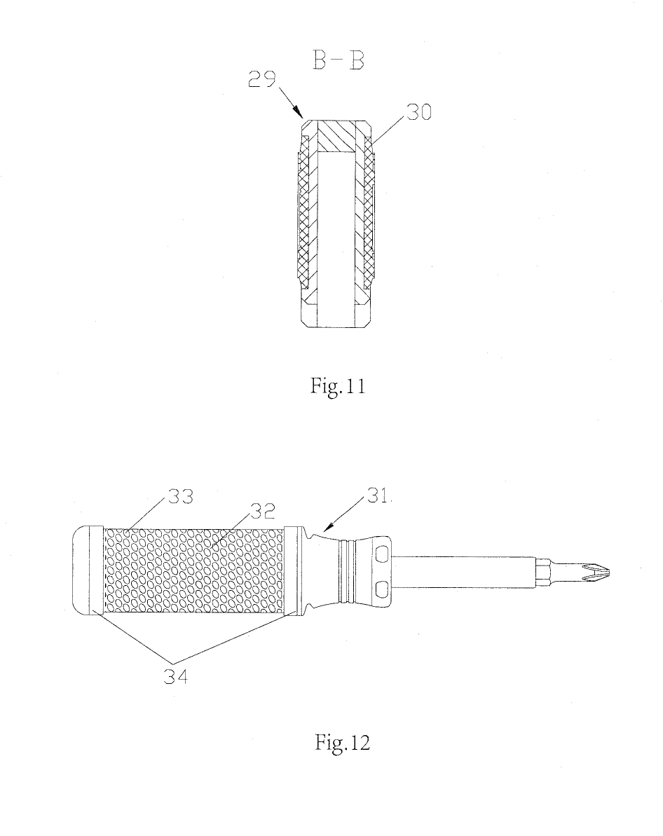

FIG. 10 is a front view of a cutter of embodiment 3 of the present invention. FIG. 11 is the section view taken along B-B line of FIG. 10. As shown in FIG. 10 and FIG. 11, the handle of the cutter includes a handle body 29, and covering layers 30, which cover the gripping part of the handle body 29 in the form of patches. Various patches of the covering layer 30 are bonded on the gripping part of the handle body 29 with adhesive.

The whole covering layer of embodiment 2 of the present invention is designed in the form of complete circles of collars. The whole covering layer of embodiment 3 of the present invention is designed in the form of patches. In another embodiment of the present invention, partial covering layer of the tool handle can be designed in the form of complete circles of collars, and partial covering layer of the tool handle can be designed in the form of patches.

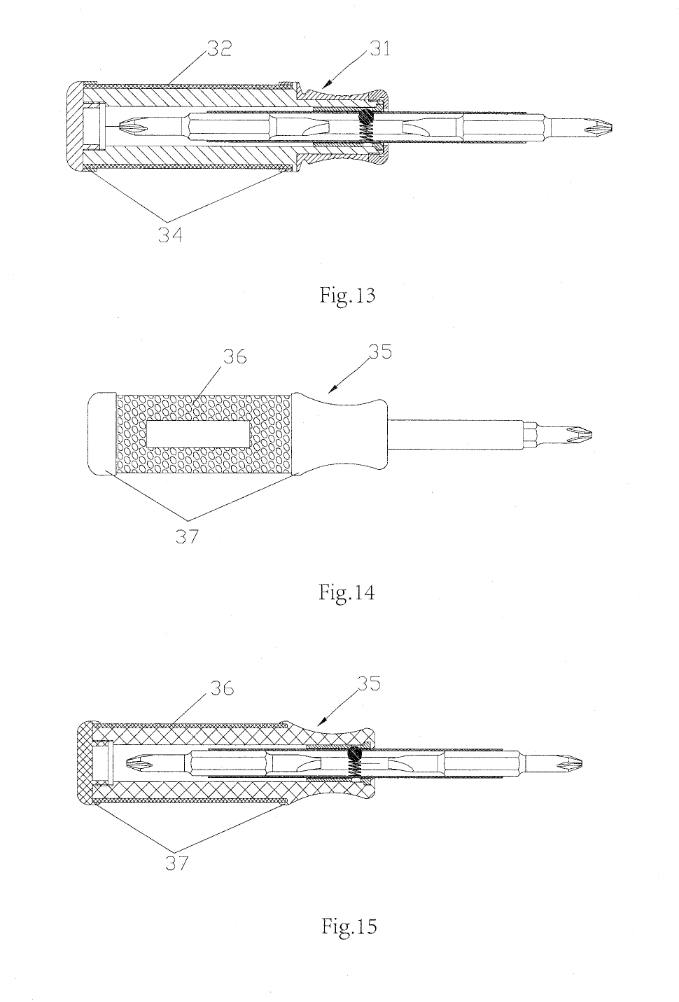

FIG. 12 is a front view of a screwdriver of embodiment 4 of the present invention. FIG. 13 is a section view of the screwdriver of embodiment 4 of the present invention. As shown in FIG. 12 and FIG. 13, the handle of the screwdriver includes a handle body 31, and a covering layer 32, which covers the gripping part of the handle body 31 in the form of a sheet. Several small bulges 33 are disposed on the outer peripheral surface of the covering layer 32 to increase the friction force between the hand and the covering layer 32, thus to improve the anti-skid performance of the handle of the screwdriver. The covering layer 32 is held on the handle body 31 with a holding hoop, so as to prevent two transverse edges of the covering layer 32 from being turned up by a hand in gripping and thus being separated from the gripping part of the handle body 31.

In another embodiment of the present invention, it is also feasible to dispose several small concave pits or combinations of small bulges and small concave pits on the outer peripheral surface of the covering layer 32, or directly engrave patterns on the outer peripheral surface of the covering layer 32, all which may increase the friction force between the hand and the covering layer 32 as well as the torsion at the time of using the tool handle, and thus to improve the anti-skid performance of the screwdriver handle.

FIG. 14 is a front view of another screwdriver of embodiment 5 of the present invention. FIG. 15 is a section view of another screwdriver of embodiment 5 of the present invention. As shown in FIG. 14 and FIG. 15, the handle of the screwdriver includes a handle body 35; and a covering layer 36, which covers the gripping part of the handle body 35 in the form of a sheet. Retaining parts 37 are disposed on the positions where the handle body 35 is connected with both ends of the covering layer 36. The retaining parts 37 and the handle body 35 are integrally made, and the covering layer 36 is pressed with the retaining parts 37 on the gripping part of the handle body 35 tightly, so as to prevent two transverse edges of covering layer 36 from being turned up by a hand in gripping and thus being separated from the gripping part of the handle body 35.

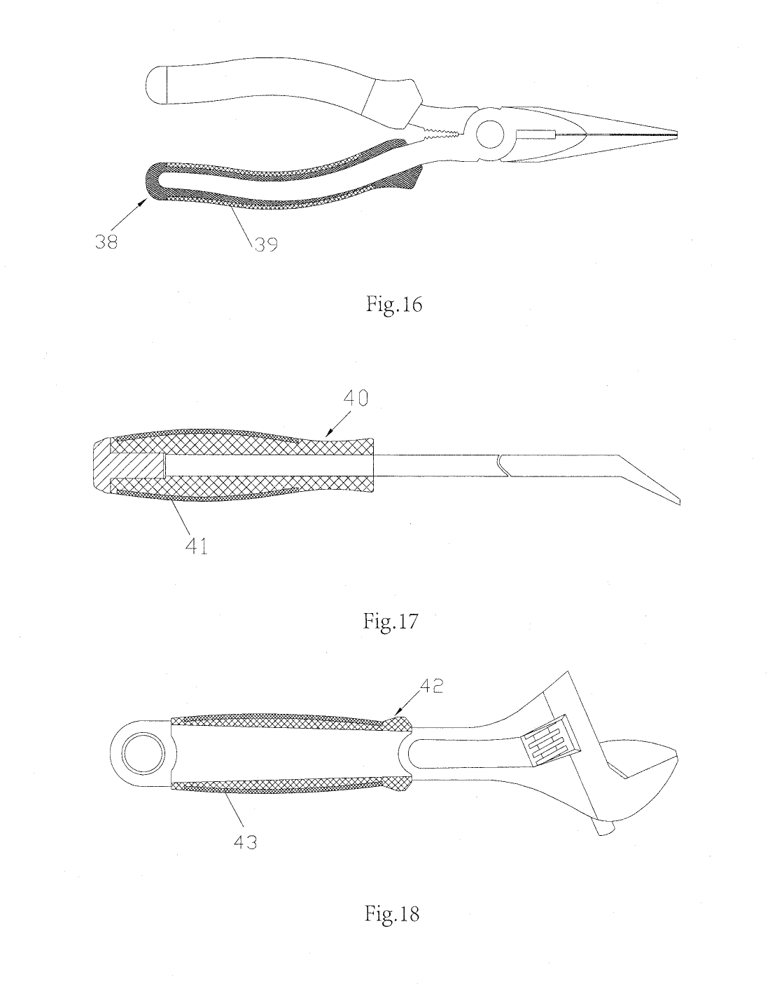

FIG. 16 is a partial section view of pliers of embodiment 6 of the present invention. As shown in FIG. 16, the handle of the pliers includes handle bodies 38, and covering layers 39, which cover the gripping parts of the handle bodies 38 in the form of sheets. Certainly, the gripping part of the handle bodies 38 also may be covered with the covering layers 39 in the form of patches or complete circles of collars. It is also feasible to dispose several small bulges, small concave pits or patterns on the outer peripheral surface of the covering layers 39.

FIG. 17 is a section view of a tommy bar of embodiment 7 of the present invention. As shown in FIG. 17, the handle of the tommy bar includes a handle body 40, and a covering layer 41, which covers the gripping part of the handle body 40 in the form of a sheet. Certainly, the gripping part of the handle body 40 also may be covered with the covering layer 41 in the form of patches or complete circles of collars. It is also feasible to dispose several small bulges, small concave pits or patterns on the outer peripheral surface of the covering layer 41.

FIG. 18 is a partial section view of a wrench of embodiment 8 of the present invention. As shown in FIG. 18, the handle of the wrench includes a handle body 42, and a covering layer 43, which covers the gripping part of the handle body 42 in the form of a sheet. Certainly, the gripping part of the handle body 42 also may be covered with the covering layer in the form of patches or complete circles of collars. It is also feasible to dispose several small bulges or small concave pits or patterns on the outer peripheral surface of the covering layer 43.

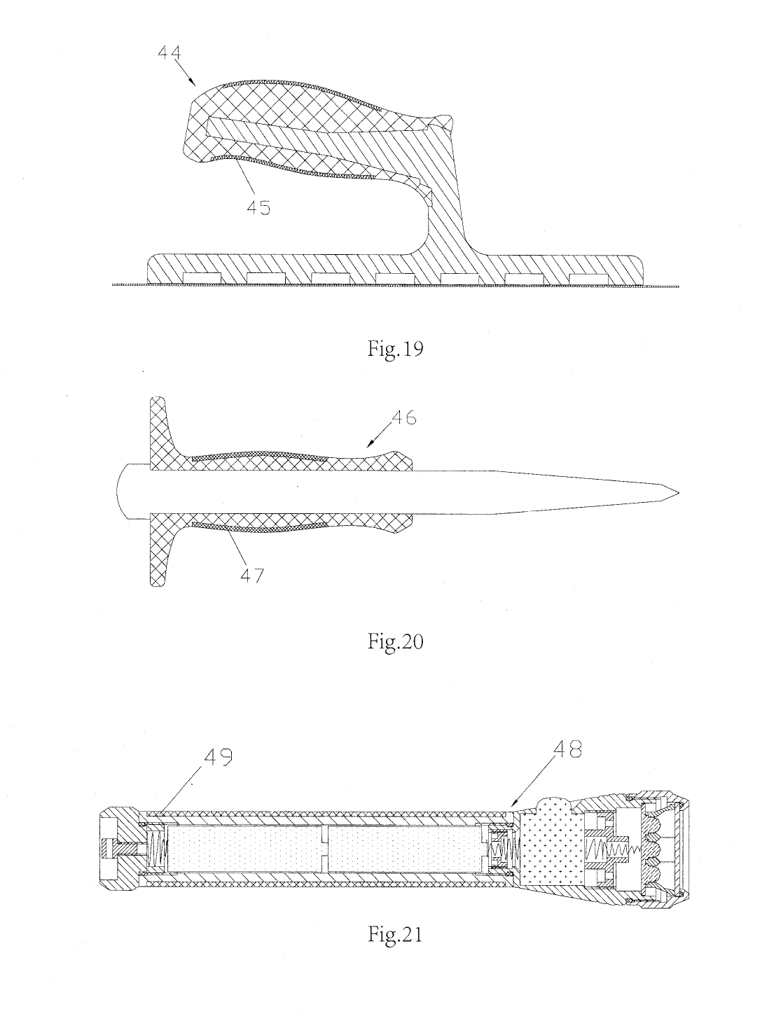

FIG. 19 is a section view of a claying tool of embodiment 9 of the present invention. As shown in FIG. 19, the handle of the claying tool includes a handle body 44, and a covering layer 45, which covers the gripping part of the handle body 44 in the form of a sheet. Certainly, the gripping part of the handle body 44 also may be covered with the covering layer 45 in the form of patches or complete circles of collars. It is also feasible to dispose several small bulges or small concave pits or patterns on the outer peripheral surface of covering layer 45.

FIG. 20 is a partial section view of a punch chisel of embodiment 10 of the present invention. As shown in FIG. 20, the handle of the punch chisel includes a handle body 46, and a covering layer 47, which covers the gripping part of the handle body 46 in the form of a sheet. Certainly, the gripping part of the handle body 46 also may be covered with the covering layer 47 in the form of patches or complete circles of collars. It is also feasible to dispose several small bulges, small concave pits or patterns on the outer peripheral surface of the covering layer 47.

FIG. 21 is a section view of a flashlight of embodiment 11 of the present invention. As shown in FIG. 21, the handle of the flashlight includes a handle body 48, and a covering layer 49, which covers the gripping part of the handle body 48 in the form of a sheet. Certainly, the gripping part of the handle body 48 also may be covered with the covering layer in the form of patches or complete circles of collars. It is also feasible to dispose several small bulges, small concave pits or patterns on the outer peripheral surface of the covering layer 49.

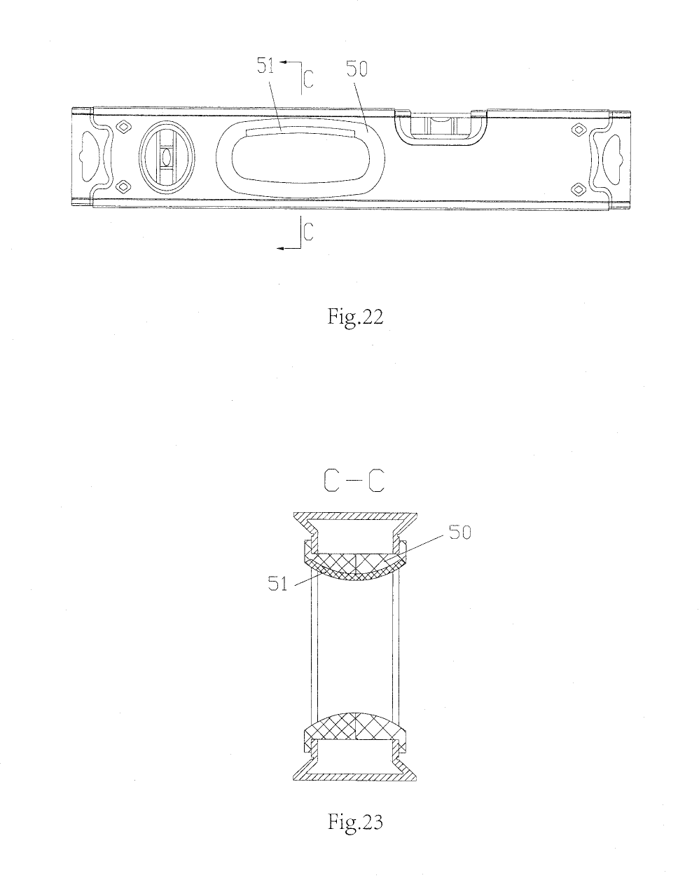

FIG. 22 is a front view of a level rule of embodiment 12 of the present invention. FIG. 23 is the section view taken along C-C line of FIG. 22. As shown in FIG. 22 and FIG. 33, the handle of the level rule includes a handle body 50, and a covering layer 51, which covers the gripping part of the handle body 50 in the form of a sheet. Certainly, the gripping part of the handle body 50 also may be covered with the covering layer 51 in the form of patches or complete circles of collars. It is also feasible to dispose several small bulges, small concave pits or patterns on the outer peripheral surface of the covering layer 51.

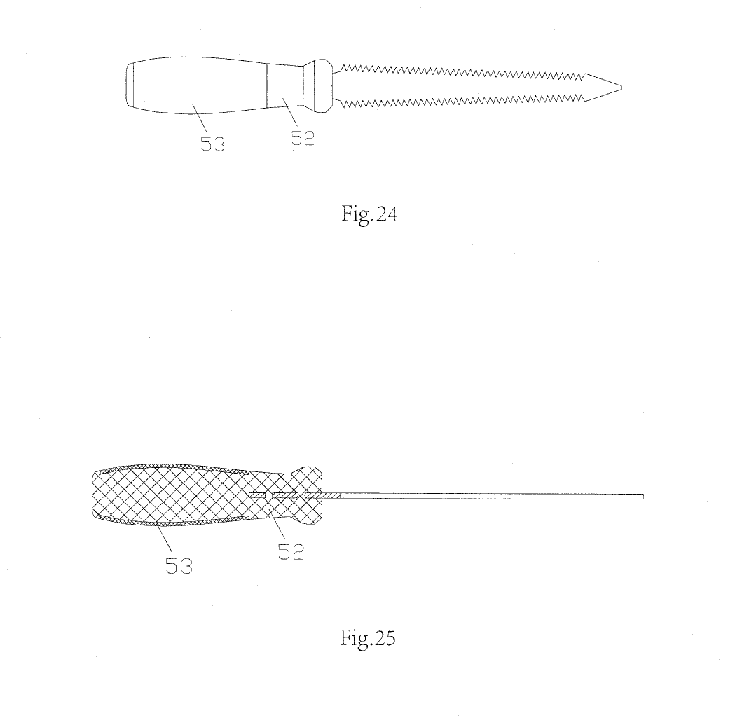

FIG. 24 is a front view of a wallboard saw of embodiment 13 of the present invention. FIG. 25 is a section view of the wallboard saw of embodiment 13 of the present invention. As shown in FIG. 24 and FIG. 25, the handle of the wallboard saw includes a handle body 52, and a covering layer 53, which covers the gripping part of the handle body 52 in the form of a sheet. Certainly, the gripping part of the handle body 52 also may be covered with the covering layer 53 in the form of patches or complete circles of collars. It is also feasible to dispose several small bulges, small concave pits or patterns on the outer peripheral surface of the covering layer 53.

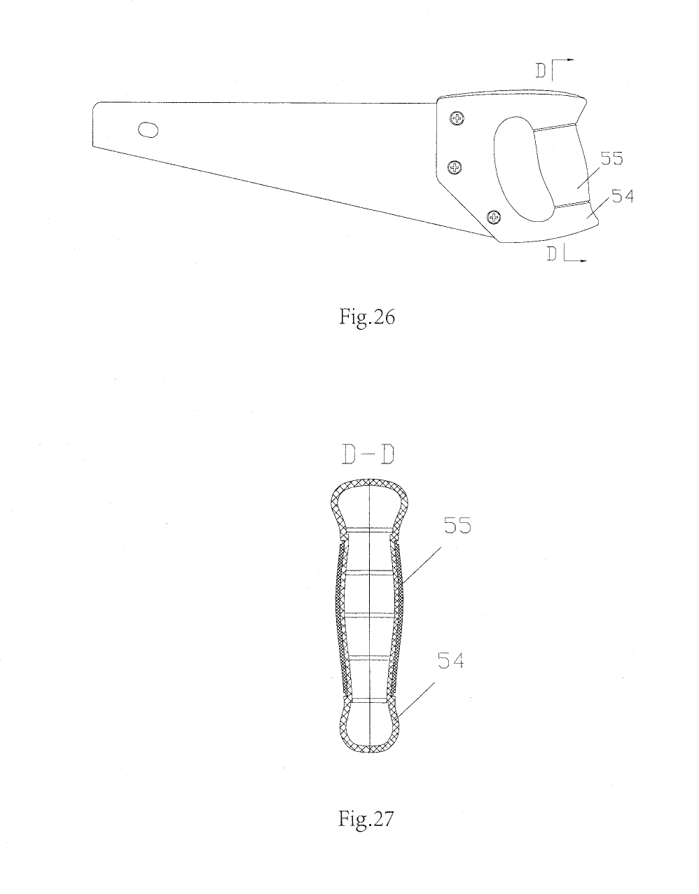

FIG. 26 is a front view of a handsaw of embodiment 14 of the present invention. FIG. 27 is the section view taken along D-D line of FIG. 26. As shown in FIG. 26 and FIG. 27, the handle of handsaw includes a handle body 54, and a covering layer 55, which covers the gripping part of the handle body 54 in the form of a sheet. Certainly, the gripping part of the handle body 54 also may be covered with the covering layer 55 in the form of patches or complete circles of collars. It is also feasible to dispose several small bulges, small concave pits or patterns on the outer peripheral surface of the covering layer 55.

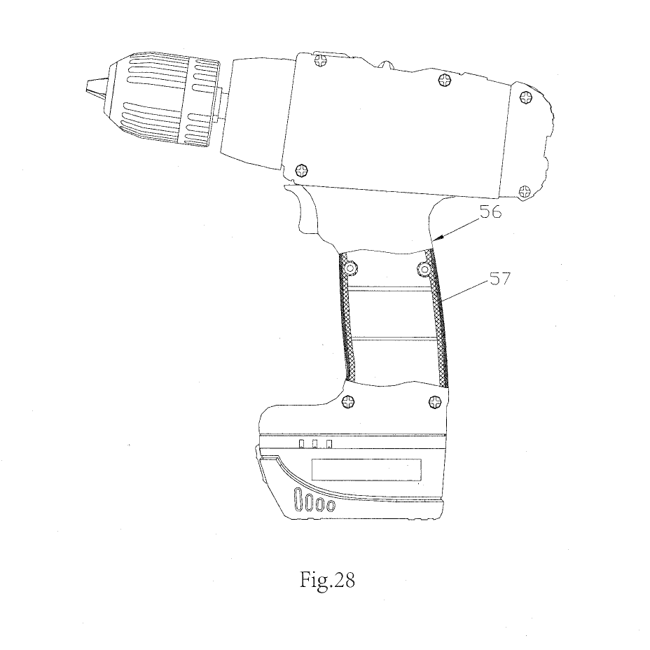

FIG. 28 is a partial section view of an electric tool of embodiment 15 of the present invention. As shown in FIG. 28, the handle of the electric tool includes a handle body 56, and a covering layer 57, which covers the gripping part of the handle body 56 in the form of a sheet. Certainly, the gripping part of the handle body 56 also may be covered with the covering layer 57 in the form of patches or complete circles of collars. It is also feasible to dispose several small bulges, small concave pits or patterns on the outer peripheral surface of the covering layer 57.

The present invention is not limited to the above mentioned embodiments, and is applicable to any tool including a handle to be gripped with a hand, in particular to a hardware tool such as a hammer, a flashlight, a screwdriver, pliers, a wrench, an electric tool, a cutter, a claying tool, a wood chisel, a tommy bar, a measuring tool, a punch chisel, a painting tool or a saw, etc. To prevent two transverse edges of the covering layer from being turned up by a hand in gripping and thus being separated from the gripping part of the handle body, it is feasible to hold the transverse edges using the holding hoop, to lean the transverse edges against the shoulders of the handle body protruding along the transverse direction or to press the transverse edges with a retaining part, etc. To improve the anti-skid performance of the tool handle, it is feasible to dispose several small bulges or small concave pits or directly engrave patterns on the outer peripheral surface of the covering layer. The covering layer can be designed as the form of a sheet, patches or complete circles of collars, etc.

The present invention also provides a manufacturing method for the tool handle. The tool handle of the present invention can be used as the handle of a hardware tool. The tool handle includes a handle body with a gripping part disposed on the handle body. The method for manufacturing the tool handle of the present invention is as follows: covering the gripping part of the handle body with an artificial leather material, so as to form the covering layer that covers a part or whole of the gripping part.

The covering layer is formed by covering the gripping part of the handle body with a sheet, and also may cover the gripping part of the handle body in the form of patches or multiple complete circles of collars.

When the covering layer is designed as the form of a sheet, the covering layer sheet includes two opposite transverse edges and two opposite longitudinal edges. Two longitudinal edges are jointed by bonding with adhesive, stitching, scarf joint or hot melting, etc. so as to form a covering sheath that is sleeved on the gripping part of the handle body.

In addition, the covering layer may be bonded on the gripping part of the handle body with adhesive, so as to further prevent the covering layer from dropping off from the gripping part.

If a through hole is disposed on the handle body, the manufacturing method further includes the following steps: placing a fastener in the through hole, and fixing the handle body with the covering layer. The fastener may be a rivet, a screw or an expansion screw, etc., and also may be a fastener including a first component and a second component that mate with each other.

Taking the process of manufacturing the handle of the hammer of embodiment 1 as an example, the method for manufacturing the tool handle of the present invention is further described as follows.

The handle of the hammer includes a handle body, and the handle body includes a handle core and a jacket that can form interference fit with the handle core. The jacket is formed through injection molding. The manufacturing method for the handle of the hammer further includes the following steps: covering the gripping part of the jacket with the covering layer first, and then making the jacket sleeved on the handle core.

In this embodiment, before the handle core is inserted into the jacket, the jacket is separately covered. The step of covering is simple and convenient. In addition, the step of covering the jacket and the step of manufacturing the handle core can be completed in different times and places, so that the efficiency of manufacturing the tool handle is significantly improved.

Certainly, it is also feasible to sleeve the jacket on the handle core first and then cover the gripping part of the jacket with the covering layer.

In another embodiment of the present invention, a handle body includes a handle core, a jacket and an inner liner that is located between the handle core and the jacket. The jacket is formed through injection molding; the inner liner is formed in the jacket through injection molding, and is integrated with the jacket. Interference fit is realized between the handle core and the inner liner. Therefore, it is feasible to reduce the accuracy requirement for the handle core and the jacket, and to effectively prevent the sloshing motion between the handle core and the inner liner. The method for manufacturing the handle of the hammer further includes the following steps: covering the gripping part of the jacket with the covering layer first, and then making the inner liner sleeved on the handle core.

In this embodiment, before the handle core is inserted into the jacket, the jacket is separately covered. The step of covering is simple and convenient. In addition, the step of covering the jacket and the step of manufacturing the handle core can be completed in different times and places, so that the efficiency of manufacturing the tool handle is significantly improved.

Certainly, it is also feasible to make the inner liner sleeved on the handle core first and then cover the gripping part of the jacket with the covering layer.

According to the method for manufacturing the tool handle of the present invention, the covering layer directly covers the gripping part of the handle body, in instead of realizing the combination between the covering layer and the gripping part through dies and injection molding steps. Therefore, the present invention is featured by simple manufacturing method and low production cost.

According to the tool handle and manufacturing method thereof of the present invention, it is feasible to firmly cover the gripping part of the handle body with the covering layer, so as to effectively buffer and absorb the vibration and impact transmitted from the handle core.

Furthermore, the covering layer is made of an artificial leather material. Being soft and wear resistant and having good hand feeling in gripping, this material can effectively improve the shock absorption performance of the tool handle. In addition, having big friction coefficient, this material can also effectively enhance the anti-skid performance of the tool handle. The covering layer is preferably made of a polyurethane material, namely a PU artificial leather material.

The tool handle and manufacturing method thereof of the present invention can be extensively applicable to any tool including the handle designed for gripping with hands, in particular to a hardware tool such as a hammer, a flashlight, a screwdriver, a pair of pliers, a wrench, an electric tool, a cutter, a claying tool, a wood chisel, a tommy bar, a measuring tool, a punch chisel, a paint tool or a saw, etc.

What stated above are merely preferred embodiments of the present invention but are not used to limit the present invention. Any modification, equivalent replacement and improvement made to the present invention without going beyond the spirit and principle of the present invention shall be within the scope of the appended claims.

1. A tool handle, including a handle body with a gripping part, further comprising a covering layer that covers a part or whole of the gripping part, wherein the covering layer is made of an artificial leather material.

2. The tool handle of claim 1, wherein the covering layer is fixed on the gripping part in the form of a sheet.

3. The tool handle of claim 2, wherein the sheet covers the gripping part in the mode of a covering sheath.

4. The tool handle of claim 2, wherein the sheet includes two opposite transverse edges and two opposite longitudinal edges, and the longitudinal edges are jointed to form the covering sheath.

5. The tool handle of claim 4, wherein the jointing of the two longitudinal edges is realized with hot-melt adhesive, stitching, scarf joint or adhesive.

6. The tool handle of claim 5, wherein the sheet is fixed on the gripping part with adhesive.

7. The tool handle of claim 4, further comprising a member for preventing at least one of the transverse edges from being turned up.

8. The tool handle of claim 7, wherein the member for preventing the edge from being turned up is a holding hoop, which is used to hold at least one of the transverse edges on the gripping part.

9. The tool handle of claim 7, wherein the member for preventing the edge from being turned up is a shoulder of the handle body, and the shoulder protrudes along a transverse direction and leans against the transverse edge of the sheet.

10. The tool handle of claim 4, wherein retaining parts protruding along a longitudinal direction are disposed on positions where the handle body is connected with both ends of the covering layer, the retaining parts and the handle body are integrally made, and the transverse edges of the covering layer are pressed tightly with the retaining parts.

11. The tool handle of claim 2, wherein the sheet covers the gripping part in the form of a single or multiple patches and/or a single or multiple complete circles of collars.

12. The tool handle of claim 1, wherein the handle body includes a connecting end part connecting to a working part, and an opposite free end part, wherein the gripping part extends between the connecting end part and the free end part; radial dimensions of the connecting end part and the free end part are respectively larger than corresponding radial dimensions of portions where the gripping part is connected with the connecting end part and the free end part, so that shoulders are formed to prevent longitudinally movement of the covering layer along the handle.

13. The tool handle of claim 12, wherein a radial dimension of the gripping part keeps constant, to form a depression with an even depth between the free end part and the connecting end part, for containing the covering layer.

14. The tool handle of claim 12, wherein a radial dimension of the gripping part gradually decreases or increases from the free end part to the connecting end part, to form a depression with a depth changing evenly between the free end part and the connecting end part, for containing the covering layer.

15. The tool handle of claim 12, wherein at positions where the connecting end part and the free end part adjoin the covering layer, an outer peripheral surface of the covering layer is aligned with rims of the connecting end part and the free end part.

16. The tool handle of claim 1, wherein the handle body further includes a through hole radially perforating through the gripping part and the covering layer, and a fastener passing the through hole to fix the covering layer and the gripping part.

17. The tool handle of claim 16, wherein a cross section of the handle body is an ellipse in shape, the ellipse including a major axis and a minor axis, wherein the through hole is perpendicular to the major axis and radially perforates through the handle body.

18. The tool handle of claim 16, wherein the fastener is a rivet, a screw or an expansion screw.

19. The tool handle of claim 16, wherein the fastener includes a first component and a second component which can mate with each other; through mating of the first component and the second component, the covering layer and the gripping part are held between the first component and the second component.

20. The tool handle of claim 19, wherein after the first component mates with the second component, ends of the first component and the second component are partially or completely aligned with outlets of the through hole of the covering layer.

21. The tool handle of claim 19, wherein the first component is a bolt and the second component is a nut for mating therewith.

22. The tool handle of claim 19, wherein the first component is a pin including a barb head, and the second component is a pin boss including an receiving part mating with the barb head.

23. The tool handle of claim 22, wherein the pin includes a pin rod, a side of the pin rod and a side of the receiving part each are provided with a locating piece, mating respectively with locating slots in the through hole of the gripping part, to position the pin and the pin boss to the gripping part.

24. The tool handle of claim 1, wherein the handle body includes a handle core and a jacket that covers the handle core, and the jacket constitutes the gripping part.

25. The tool handle of claim 24, wherein the handle body further includes an inner liner located between the handle core and the jacket.

26. The tool handle of claim 25, wherein the material for the jacket is harder than the material for the inner liner.

27. The tool handle of claim 25, wherein the inner liner and the jacket are integrally made through injection molding.

28. The tool handle of claim 25, wherein interference fit is formed between the inner liner and the handle core.

29. The tool handle of claim 1, wherein several bulges or concave parts are disposed on an outer peripheral surface of the covering layer, so as to improve the anti-skid performance.

30. The tool handle of claim 1, wherein the artificial leather material is a polyurethane material.

31. The tool handle of claim 1, wherein the tool is a hardware tool.

32. The tool handle of claim 31, wherein the hardware tool is a hammer, a flashlight, a screwdriver, a pair of pliers, a wrench, an electric tool, a cutter, a claying tool, a wood chisel, a tommy bar, a measuring tool, a punch chisel, a painting tool or a saw.

33. A method for manufacturing a tool handle, the tool handle including a handle body, comprising a step of covering a gripping part of the handle body with an artificial leather material, so as to form a covering layer that covers a part or whole of the gripping part.

34. The method for manufacturing a tool handle of claim 33, wherein the covering layer is formed by covering the gripping part with a sheet.

35. The method for manufacturing a tool handle of claim 34, comprising the step of making the sheet form a covering sheath to cover the gripping part.

36. The method for manufacturing a tool handle of claim 35, further comprising a step of jointing two longitudinal edges of the sheet to form the covering sheath.

37. The method for manufacturing a tool handle of claim 36, wherein the two longitudinal edges of the sheet are jointed together by bonding with adhesive, stitching, scarf joint or hot melting.

38. The method for manufacturing a tool handle of claim 34, further comprising a step of bonding the sheet on the gripping part of the handle body with adhesive.

39. The method for manufacturing a tool handle of claim 33, wherein the handle body includes a handle core and a jacket that can form interference fit with the handle core; after the covering layer covers the jacket, the jacket is sleeved on the handle core.

40. The method for manufacturing a tool handle of claim 33, wherein the handle body includes a handle core and a jacket that can form interference fit with the handle core; after the jacket is sleeved on the handle core, the covering layer covers the jacket.

41. The method for manufacturing a tool handle of claim 33, wherein the handle body includes a handle core, a jacket and an inner liner located between the handle core and jacket; the inner liner is formed in the jacket through injection molding and can form interference fit with the handle core; after the covering layer covers the jacket, the inner liner is sleeved on the handle core.

42. The method for manufacturing a tool handle of claim 33, wherein the handle body includes a handle core, a jacket and an inner liner located between the handle core and the jacket; the inner liner is formed in the jacket through injection molding and can form interference fit with the handle core; after the inner liner is sleeved on the handle core, the covering layer covers the jacket.

43. The method for manufacturing a tool handle of claim 33, wherein the artificial leather material is a polyurethane material.

44. The method for manufacturing a tool handle of claim 33, wherein the tool is a hardware tool.

45. The method for manufacturing a tool handle of claim 44, wherein the hardware tool is a hammer, a flashlight, a screwdriver, a pair of pliers, a wrench, an electric tool, a cutter, a claying tool, a wood chisel, a tommy bar, a measuring tool, a punch chisel, a painting tool or a saw.
